(19) United States
(12) Patent Application Publication
(10) Pub. No.: US 2006/0146940 A1
(43) Pub. Date: Jul. 6, 2006

(54) Spatial error concealment based on the intra-prediction modes transmitted in a coded stream

(75) Inventors: Cristina Gomila, Princeton, NJ (US); Peng Yin, Plainsboro, NJ (US)

Correspondence Address: THOMSON LICENSING INC., PATENT OPERATIONS, PO BOX 5312, PRINCETON, NJ, 08543-5312, US

(73) Assignee: THOMSON LICENSING S.A., Boulogne-Billancourt (FR)

(21) Appl. No.: 10/541,778

(22) PCT Filed: Jul. 8, 2003
(86) PCT No.: PCT/US03/21494

§ 371 Date: Jul. 11, 2005

Related U.S. Application Data
(60) Provisional application No. 60/439,189, filed on Jan. 10, 2003.

(51) Int. Cl. H04B 1/66; H04N 7/12; H04N 11/04; H04N 11/02

(52) U.S. Cl. 375/240.27; 375/240.24; 375/240.12

(57) ABSTRACT

Spatial concealment of errors in an intra picture comprised of a stream of macroblocks is achieved by predicting the missing data in a macroblock based on an intra prediction mode specified in neighboring block. In practice, when macroblocks within a stream are coded by a block based coding technique, such as coding technique specified in the H.264 ISO/ITU standard, a macroblock can be predicted for coding purpose based on neighboring intra prediction modes specified by the coding technique.

### CROSS REFERENCE TO RELATED APPLICATION

This application claims priority under 35 U.S.C. 119(e) to U.S. Provisional Patent Application Ser. No. 60/439,189 filed Jan. 10, 2003, the teachings of which are incorporated herein.

### TECHNICAL FIELD

This invention relates to a technique for correcting errors appearing in a coded image within a coded video stream.

### BACKGROUND ART

In many instances, video streams undergo compression (coding) to facilitate storage and transmission. Not infrequently, such coded video streams incur data losses or become corrupted during transmission because of channel errors and/or network congestion. Upon decoding, the loss/corruption of data manifests itself as missing pixel values. To reduce such artifacts, a decoder will “conceal” such missing pixel values by estimating the value from other macroblocks in the same image or from other image. The term conceal is a somewhat of a misnomer because the decoder does not actually hide missing or corrupted pixel values errors. Spatial concealment seeks to derive the missing/corrupted pixel values by using pixel values from other areas in the image relying on the similarity between neighboring regions in the spatial domain. Typically, at the same level of complexity, spatial concealment techniques achieve lower performance than temporal error concealment techniques that rely on information from other transmitted pictures.

An error concealment algorithm should invoke spatial interpolation only in those instances where no temporal option is available, that is, when losses affect intra-coded pictures, intra refresh pictures or when no temporal information is available. The quality of future inter-coded frames that use a concealed image as a reference will depend on the quality of the spatial concealment. When the spatial concealment yields a relatively poor intra-coded picture, each resultant inter-coded picture will likewise have poor quality.

Several techniques currently exist for spatial error concealment. They include:

Block copy (BC)

With this approach, the replacement of a missing/corrupted macroblock is obtained from one of its correctly decoded neighbors.

Pixel domain interpolation (PDI):

The missing/corrupted macroblock data is interpolated from the pixel values at the border of the correctly decoded neighbors. Two different approaches exist for accomplishing PDI. For example, all the pixels within a macroblock can be interpolated to a common mean value. Alternatively, each pixel value is obtained by means of a weighted prediction based on the pixel distance to the macroblock boundaries.

Multi-directional interpolation (MDI)

The multi-directional interpolation technique constitutes an improved version of the PDI technique because the MDI technique provides interpolation along the edge directions. Accomplishing MDI requires estimating the directions of the main contours in the neighborhood of the missing/corrupted pixel value prior to directional interpolation. Performing edge detection and quantization on a limited number of directions remains a difficult problem.

Maximally smooth recovery (MSR):

In the Discrete Cosine Transformation (DCT) domain, low frequency components are used for error concealment to provide a smooth connection with the adjacent pixels. When data-partitioning encoding is used, the MSR technique exploits the correctly received DCT coefficients instead of discarding all the data within the corrupted macroblock/block.

Projection on convex sets (POCS):

In accordance with this technique, adaptive filtering is performed in the Fast Fourier Transform (FFT) domain, based on the classification of a larger region surrounding the macroblock with missing/corrupted pixel values. Such adaptive filtering includes the application of low-pass filtering on smooth regions while applying an edge filter on sharp regions. This procedure includes a filtering iteration and several a priori constraints will apply to the treated image.

Table 1 highlights the tradeoff between complexity and quality of the different known approaches to achieving spatial concealment.

TABLE 1

| Concealment | | |
|---|---|---|
| Technique | Complexity | Quality |
| BC | Low | Low with blocking artifacts |
| PDI | Low/Medium | Low with blurred contours |
| MDI | Medium/High | Good on edges and sharp images |
| MSR | High | Best as complement of data partitioning |
| POCS | High | Good on textured regions |

In connection with spatial error concealment, video decoders face a challenging tradeoff between affordable computational complexity and the desired quality of the recovered image. Typically, most video decoders only implement fast algorithms, such as the BC or PDI algorithms for real-time applications. As described, these algorithms roughly cover the lost/corrupted areas by copying or averaging the neighboring values. Such strategies result in a low quality image with artifacts visible even when displayed at a high frame rate.

Thus, there is a need for a spatial error concealment technique that overcomes the foregoing disadvantages by proving good quality concealment on edges with low/medium complexity.

### BRIEF SUMMARY OF THE INVENTION

Briefly, in accordance with the present principles, there is provided a technique for spatial concealment of errors in a coded image comprised of a stream of macroblocks. The method commences by identifying errors in the form of a macroblock having missing/corrupted pixel values. For each identified macroblock, at least one intra-prediction mode is derived from neighboring macroblocks. When the image is coded in accordance with the ISO/ITU H.264 video compression standard, two intra-coding types are available for the coding of each macroblock: (1) for an Intra_{—}16×16 type, a single intra prediction mode is derived for the whole macroblock; (2) for an Intra_{—}4×4 type, an intra prediction mode is derived for each sub-macroblock of 4×4 pixels within the macroblock. (In this case, there are sixteen intra prediction modes per coded macroblock.) Finally, the derived intra-prediction modes are applied to generate the missing pixel values. The process by which the derived intra prediction modes are applied to estimate missing or corrupted pixel values corresponds to the derivation process employed during decoding to estimate (predict) coded values to reduce the coding effort. In other words, the present technique utilizes the intra prediction mode information normally used in coding for spatial error concealment purposes. When the coded data referring to a particular macroblock is lost or corrupted, the intra prediction modes derived from neighboring macroblocks can provide important information about which is the best interpolation direction for spatial error concealment. Using the intra prediction modes for spatial error concealment yields significantly better performance than the classical spatial error concealment techniques with similar complexity.

### BRIEF DESCRIPTION OF THE DRAWINGS

FIG. 1 depicts a coded picture partitioned into macroblocks, with each macroblock partitioned into blocks, and each block partitioned into pixels;

FIG. 2A depicts a vector display of intra prediction mode directions for establishing prediction error values for coding purposes;

FIGS. 2B-2J each depicts a 4×4 sub-macroblock indicating a separate one of the corresponding intra-mode prediction directions depicted in FIG. 2A;

FIG. 3 depicts a support window for use in accomplishing spatial error concealment using intra-prediction modes in accordance with the present principles; and

FIG. 4 depicts in flow chart form a process for decoding a coded image that includes spatial error concealment in accordance with present principles.

### DETAILED DESCRIPTION

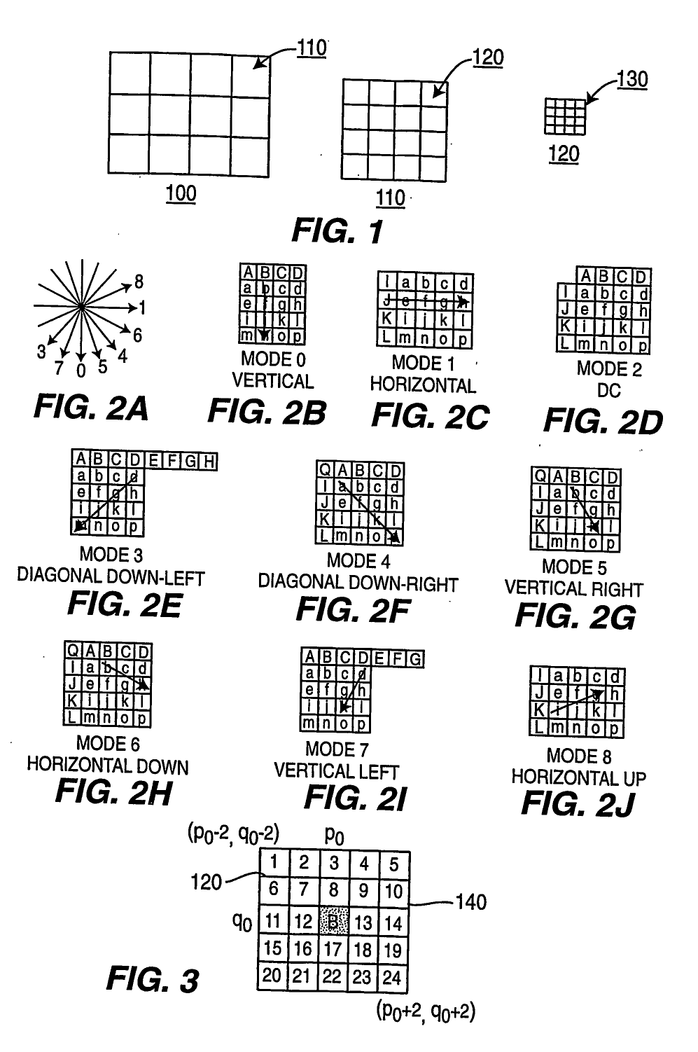

Block-based video compression techniques, such as embodied in the proposed ISO/ITU H.264 video compression standard, operate by dividing a picture into slices, each slice comprising a set of macroblocks or macroblock pairs, with each macroblock coded in accordance with the standard. Macroblocks are typically defined as squared regions of 16×16 pixels. For coding purposes, macroblocks can be further partitioned into sub-macroblocks not necessarily squared. Each one of the sub-macroblocks can have different coding modes when the macroblock is encoded. For ease of discussion, a block will be referred to as a sub-macroblock of 4×4 pixels. FIG. 1 depicts the partitioning of a coded picture 100 into macroblocks 110, with each macroblock 110 partitioned into blocks 120, and each block partitioned into pixels 130. The partitioned image 100 of FIG. 1 comprises n rows by m columns of macroblocks 110 where n and m are integers. Note that the number of macroblocks within a picture varies depending on the size of the picture, while the number of blocks within a macroblock is constant.

To reduce the cost of individually coding each macroblock 110 within the partitioned image 100, information from already transmitted macroblocks can be used to yield a prediction of the coding of an individual macroblock. In this case, only the prediction error and the prediction mode require transmission. The video coding standard employed to code the image will specify the process for deriving the predicted pixel values in order to ensure that both the encoder (not shown) and the decoder (not shown) obtain the same estimation. In accordance with the ISO/ITU H.264 standard, individual macroblocks can be intra-predicted either as a single partition of 16×16 pixels (Intra_{—}16×16 type coding or as partition of 16 blocks of 4×4 pixels (Intra_{—}4×4 type coding). For the Intra_{—}16×16 type coding, the ISO/ITU H.264 standard specifies four intra-prediction modes: Mode 0, vertical prediction; Mode 1, horizontal prediction; Mode 2, DC prediction; Mode 3, plane prediction. For the Intra_{—}4×4 coding type, the ISO/ITU H.264 standard specifies nine intra-prediction modes, each one having associated an interpolation filter to derive a prediction for each pixel within a block when using this mode for prediction: Mode 0, vertical prediction; Mode 1, horizontal prediction; Mode 2, DC prediction; Mode 3, diagonal down-left prediction; Mode 4, diagonal down-right prediction; Mode 5, vertical right prediction; Mode 6, horizontal down prediction; Mode 7, vertical left prediction; and Mode 8, horizontal up prediction.

FIG. 2A depicts a vector display indicating the direction of each of the intra-prediction modes 0-8 specified by the ISO/ITU H.264 standard. (Note that Mode 2, corresponding to the DC mode, has no direction, since it uniformly predicts the content of a block within a homogeneous region.) The other modes 0-1 and 3-8 predict the content of a macroblock along one of the eight quantized directions. When encoded at an encoder (not shown), the mode prediction direction associated with each intra-coded macroblock is sent in the coded stream. The decoder (not shown) uses the intra mode prediction direction in conjunction with the interpolation filters to predict the contents of a block from the pixel values of the neighboring blocks already decoded. Each interpolation filter defines the appropriate weighting factors to propagate the information in the direction associated with the intra-prediction mode, as seen in each of FIGS. 2B-2J.

In accordance with the present principles, the intra prediction mode, normally used for decoding purposes, can also provide a very good mechanism for estimating missing or corrupted pixel values in a macroblock for accomplishing spatial error concealment. When the coded data associated with a particular macroblock appears lost or missing, the intra prediction modes already used to estimate the content of the neighboring blocks can provide important information about the best interpolation direction for estimating the lost pixel values for accomplishing spatial error concealment.

Any number of neighboring blocks 120 within the partitioned image 100 of FIG. 1 can serve as predictors for a block having missing or corrupted pixels. In practice, limiting the number of blocks 120 within the neighborhood of the block having missing or corrupted pixels reduces complexity. To that end, a support window 140, as depicted in FIG. 3, is defined to limit to the number of neighboring blocks 120 considered for spatial concealment purposes. As will be appreciated, the larger the size of the support window 140 (and hence the larger the number of neighboring blocks), the more reliable the selection of the intra-mode for predicting the missing block, but at the cost of increased complexity. Not all the blocks within the defined support window 140 of FIG. 3 are needed to conceal a block of interest by intra-mode prediction. One or more of the blocks 120 within the support window 140 could also require concealment (i.e., no information is available for them) or such blocks are simply not relevant for the intra-mode selection criteria. In the simplest case, the intra prediction mode could rely on the blocks above and to the left of the block requiring concealment.

Referring to FIG. 3, the following notation will serve to define the neighboring blocks 120 in the support window 140. The block B within the support window 140 requiring concealment has the coordinates (p₀, q₀). Accordingly, the support window 140 thus becomes a rectangle centered on block B, with coordinates (p₀-P, q₀-Q) on its upper left corner and coordinates (p₀+P, q₀+Q) on its lower right corner, where P and Q comprise integers that specify the number of support window rows and columns, respectively. In the illustrative embodiment depicted in FIG. 3, P=Q=2, defining a squared neighborhood of 5×5 blocks centered on block B.

For a practical implementation, criteria must be defined for selecting an intra-mode prediction from those available within the support window. According to the present principles, the relative position of the intra prediction modes within the support window 140 serves as an input to the intra-mode selecting criteria. Because each intra prediction mode defines a direction of interpolation, the macroblocks having such a mode only become relevant for concealment purposes when such macroblocks appear at some relative positions within the support window 140.

To unequivocally specify a block within the support window 140, the blocks 120 are labeled in raster scan order as shown in FIG. 3. According to the proposed criteria, selection of a mode for concealment of the central block B in the support window 140 occurs if, and only if, this mode appears in the associated spatial direction as illustrated in FIG. 2A. For example, the block B will be concealed from data obtained along the diagonal down-left direction in FIG. 3 only if either the block #9 or the block #16 has been predicted in the diagonal down-left direction. The inclusion of other blocks in the criterion has been done to reduce the sensibility of the selecting criteria to the spurious use of a certain mode on the coded stream. Note that these conditions apply only to those neighboring blocks within the support window 140 correctly received or already concealed. Furthermore, not all the neighboring blocks within the defined support window 140 become involved in the selection of an intra-mode for the current block undergoing spatial concealment.

Table 2 provides an exemplary embodiment of the selecting criteria for a support window 140 of 5×5 blocks centered on the block to be concealed.

TABLE 2

| Selected mode | Mode on neighbors |
|---|---|
| Vertical left | (#4 and (#9 or #8)) or (#9 and #8) |
| | or |
| | (#21 and (#16 or #17)) or (#16 and #17) |
| Vertical right | (#2 and (#7 or #8)) or (#7 and #8) |
| | or |
| | (#23 and (#18 or #17)) or (#18 and #17) |
| Horizontal up | (#10 and (#9 or #13)) or |
| | (#15 and (#16 or #12)) |
| Horizontal down | (#6 and (#7 or #12)) or |
| | (#19 and (#18 or #13) |
| Diagonal down-left | (#9 and (#5 or #8)) or |
| | (#16 and (#20 or #17)) |
| Diagonal down-right | (#7 and (#1 or #8)) or |
| | (#18 and (#24 or #17)) |
| Vertical | (#8 and (#7 or #9)) or |
| | (#17 and (#16 or #18)) |
| Horizontal | (#8 and (#7 or #9)) or |
| | (#17 and (#16 or #18)) |
| DC | Otherwise |

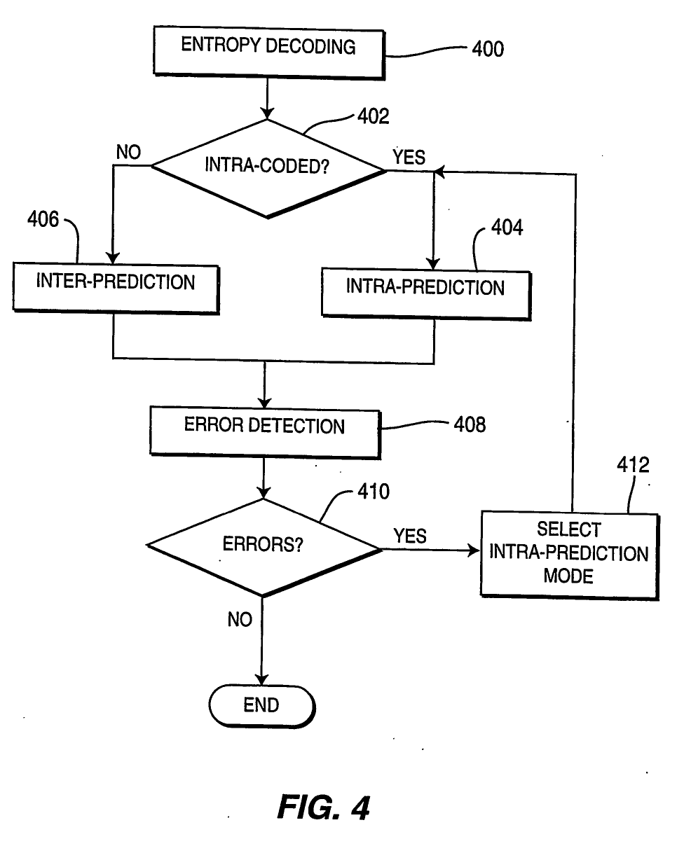

In a preferred embodiment, spatial error concealment typically occurs during decoding in the manner depicted in flow chart form in FIG. 4. The decoding process depicted in FIG. 4 commences with entropy decoding of macroblocks of an incoming (input) coded video stream in accordance with control parameters and input data during step 400. In connection with such decoding, a determination occurs during step 402 whether the coded image constitutes an intra coded image. If so, then the coding difference (prediction error) is obtained by intra prediction during step 404; otherwise such prediction error is established by inter prediction during step 406. Following steps 404 and 406, error detection occurs during step 408 to enable a determination during step 410 whether a macroblock contains missing or corrupted pixel values. If the prediction values for neighboring macroblocks in the established support window 140 of FIG. 3 had been established from intra prediction, then the spatial errors undergo concealment by selecting the intra prediction mode, whereupon step 402 is re-executed. The establishment of prediction values in neighboring macroblocks by inter-prediction rather than intra prediction will require estimating the missing/lost pixel values by other than intra prediction.

Empirical testing using as input data the intra prediction modes provided by the reference software of the H.264 standard (JM50 version) has yielded superior results compared to classical spatial concealment techniques with similar complexity. Peak Signal-to-Noise Ratio values increased for all test images, showing an improved visual quality because of the good prediction of contours in the missing zones.

The foregoing describes a technique for concealing spatial errors in a coded video stream using intra-prediction modes normally associated with coding prediction.

1. A method of concealing spatial errors in a coded image comprised of a stream of macroblocks, comprising the steps of:
examining each macroblock for pixel data errors, and if such errors exist, then:
establishing at least one intra-prediction mode from neighboring blocks, and then
deriving estimated pixel data in accordance with the at least one established intra prediction mode to correct the pixel data errors.

2. The method according to claim 1 wherein the coded imaged is coded in accordance with a predetermined coding standard and wherein the intra prediction mode is specified by the predetermined coding standard.

3. The method according to claim 2 wherein the coded imaged is coded in accordance with the ISO/ITU H.264 coding standard and wherein the intra prediction mode is specified by the ISO/ITU H.264 coding standard.

4. The method according to claim 1 wherein the establishing of at least one intra-prediction mode is limited to information within a rectangular array of blocks centered about the block having missing pixel data.

5. The method according to claim 3 wherein the at least one intra prediction mode is established in accordance with a relative position of intra prediction modes of macroblocks neighboring the macroblock with pixel data errors.

6. A method of concealing spatial errors in a coded image comprised of a stream of macroblocks coded in accordance with the ISO/ITU H.264 Standard, the method comprising the steps of:
examining each macroblock for pixel data errors, and if so, then:
deriving at least one intra-prediction mode from neighboring blocks, the mode specified by the ISO/ITU H.264 standard; and
applying at least one interpolation filter corresponding the at least one derived intra prediction mode to estimate the pixel data to correct the pixel data errors.

7. The method according to claim 6 wherein the establishing of at least one intra-prediction mode is limited to information within a rectangular array of blocks centered about the block having missing data.

8. The method according to claim 7 wherein the establishing of the at least one intra-prediction mode is made in accordance with a relative position of intra prediction modes of blocks neighboring the block with missing pixel data.

9. The method according to claim 6 wherein an individual macroblocks can be intra-predicted as one of a single partition of 16×16 pixels (Intra_{—}16×16 type coding) or as partition of 16 blocks of 4×4 pixels (Intra_{—}4×4 type coding).

10. The method according to claim 9 wherein for the Intra_{—}16×16 type coding, the intra prediction modes comprise: (a) Mode 0, vertical prediction; (b) Mode 1, horizontal prediction; (c) Mode 2, DC prediction; and (d) Mode 3, plane prediction.

11. The method according to claim 9 wherein for the Intra_{—}4×4 coding type, the prediction modes each one having associated an interpolation filter to derive a prediction for each pixel within a block.

12. The method according to claim 9 wherein the prediction modes comprise: (a) Mode 0, vertical prediction; (b) Mode 1, horizontal prediction; (c) Mode 2, DC prediction; (d) Mode 3, diagonal down-left prediction; (e) Mode 4, diagonal down-right prediction; (f) Mode 5, vertical right prediction; (g) Mode 6, horizontal down prediction; (h) Mode 7, vertical left prediction; and (i) Mode 8, horizontal up prediction.
